(19) United States
(12) Patent Application Publication
(10) Pub. No.: US 2016/0294805 A1
(43) Pub. Date: Oct. 6, 2016

(54) METHOD AND TERMINAL DEVICE FOR ACCESSING NETWORK

(71) Applicant: Xiaomi Inc., Beijing (CN)

(72) Inventors: Qiao Ren, Beijing (CN); Enxing Hou, Beijing (CN); Ziguang Gao, Beijing (CN)

(21) Appl. No.: 14/953,037

(22) Filed: Nov. 27, 2015

(30) Foreign Application Priority Data
Mar. 30, 2015 (CN) 201510146174.3

(51) Int. Cl. H04L 29/06

(52) U.S. Cl. CPC H04L 63/083

(57) ABSTRACT

A method and a terminal device for accessing network are provided. The method includes: prompting to input a Service Set Identifier (SSID) and an access password for accessing a router when a network access request is received from an accessing device; comparing the SSID and the access password input with an SSID and an access passwords in a historical network access data record; and transmitting the SSID and the access password input to the accessing device if the SSID and the access password input match the SSID and the access password in the historical network access data record. The accessing device will access a corresponding server based on the SSID and the access password transmitted by the terminal device. The method is applicable to facilitate the accessing device to access network via a terminal device.

### CROSS-REFERENCE TO RELATED APPLICATIONS

This application is based on and claims priority to Chinese Patent Application No. 201510146174.3, filed on Mar. 30, 2015, the entire contents of which are incorporated herein by reference.

### TECHNICAL FIELD

The present disclosure generally relates to technical field of wireless communications, and more particularly, to a method and a terminal device for accessing network.

### BACKGROUND

Nowadays, there are various kinds of smart devices capable of accessing network, such as STBs (set-up box), smart sockets, smart air purifiers, mobile routers. Although those devices are able to access network, some of them need auxiliary operation from users for the first time to access network due to a lack of an input interface. At that moment, the users may need to send an SSID (Service Set Identifier) and an access password for the network to be accessed to the smart devices via another device having an input interface, such as a mobile phone, a computer or the like, so as to enable the smart devices to access the network.

### SUMMARY

Embodiments of the present disclosure provide a method and a terminal device for accessing network.

According to a first aspect of embodiments of the present disclosure, there is provided a method for accessing network, implemented by a terminal device, including: prompting to input an SSID and an access password for accessing a router when a network access request is received from an accessing device; comparing the SSID and the access password input with an SSID and an access passwords in a historical network access data record; and transmitting the SSID and the access password input to the accessing device if the SSID and the access password input match the SSID and the access password in the historical network access data record, the accessing device accessing a corresponding server based on the SSID and the access password transmitted by the terminal device.

In the present embodiment, the terminal device may provide an interface for inputting the SSID and the access password of the router upon receiving the network access request, and compare the SSID and the access password input by a user with the prestored historical network access data record after the user inputs the SSID and the access password via the interface. If a result of comparison shows that there is a match, the SSID and the access password input by the user may be transmitted to the accessing device via broadcasting. Upon receiving a broadcasting diagram, the accessing device in a listening state may extract the SSID and the access password therefrom, so as to establish a network connection with a designated router by transmitting an access request to the router. Thus, an accuracy of the SSID and the access password obtained by the accessing device may be improved, and a success rate for the accessing device to access the router is improved.

In the present embodiment, the terminal device may try to access the corresponding server with the SSID and the access password input by the user before broadcasting the SSID and the access password, and it may be deemed that the SSID and the access password are correct and the server functions normally if the access succeeds. Thus, an accuracy of the SSID and the access password obtained by the accessing device may be improved, and a success rate for the accessing device to access the router is improved.

According to a second aspect of embodiments of the present disclosure, there is provided a terminal device for accessing network, including: a processor; and a memory for storing instructions executable by the processor; wherein the processor is configured to perform: prompting to input an SSID and an access password for accessing a router when a network access request is received from an accessing device; comparing the SSID and the access password input with an SSID and an access password in a historical network access data record; and transmitting the SSID and the access password input to the accessing device if the SSID and the access password input match the SSID and the access password in the historical network access data record, the accessing device accessing a corresponding server based on the SSID and the access password transmitted by the terminal device.

According to a third aspect of embodiments of the present disclosure, there is provided a non-transitory computer-readable storage medium having stored therein instructions that, when executed by a processor of a terminal device, cause the terminal device to perform a method for accessing network, the method including: prompting to input an SSID and an access password for accessing a router when a network access request is received from an accessing device; comparing the SSID and the access password input with an SSID and an access passwords in a historical network access data record; and transmitting the SSID and the access password input to the accessing device if the SSID and the access password input match the SSID and the access password in the historical network access data record, the accessing device accessing the corresponding server based on the SSID and the access password transmitted by the terminal device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for accessing network according to an exemplary embodiment.

FIG. 2 is a flow chart illustrating a method for accessing network according to another exemplary embodiment.

FIG. 3 is a flow chart illustrating a method for accessing network according to yet another exemplary embodiment.

FIG. 4 is a flow chart illustrating a method for accessing network according to yet another exemplary embodiment.

FIG. 5 is a block diagram illustrating an apparatus for accessing network according to an exemplary embodiment.

FIG. 6 is a block diagram illustrating an apparatus for accessing network according to another exemplary embodiment.

FIG. 7 is a block diagram illustrating transmission module according to an exemplary embodiment.

FIG. 8 is a block diagram illustrating an apparatus for accessing network according to an exemplary embodiment.

FIG. 9 is a block diagram illustrating a terminal device used for accessing network according to an exemplary embodiment.

Specific embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

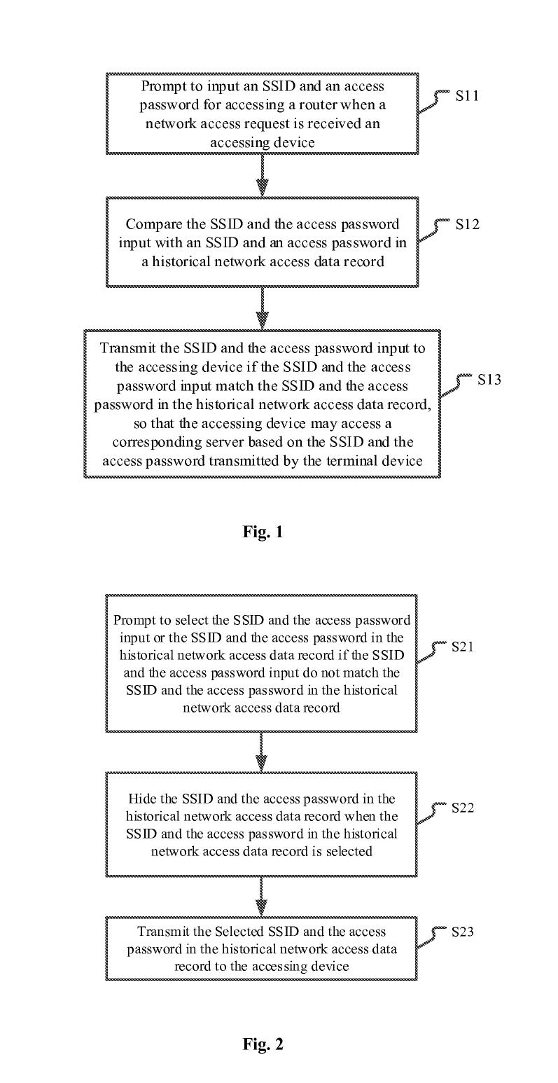

FIG. 1 is a flow chart illustrating a method for accessing network according to an exemplary embodiment. As shown in FIG. 1, the method for accessing network may be implemented by a terminal device, and may include following steps.

In step S11, prompting to input an SSID and an access password for accessing a router when a network access request is received from an accessing device; in step S12, comparing the SSID and the access password input with an SSID and an access password in a historical network access data record; and in step S13, transmitting the SSID and the access password input to the accessing device if the SSID and the access password input match the SSID and the access password in the historical network access data record, so that the accessing device may access the corresponding server based on the SSID and the access password transmitted by the terminal device.

In the present embodiment, those accessing devices being capable of accessing network, such as STBs, smart sockets, smart air purifiers, and mobile routers, may be in a listening state before accessing a router, and may send the network access request to a terminal device having an input interface such as a mobile phone, a computer or the like. The terminal device may provide an interface for inputting the SSID and the access password of the router upon receiving the network access request, and compare the S SID and the access password input by a user with the prestored historical network access data record after the user inputs the SSID and the access password via the interface. If a result of comparison shows that there is a match, the SSID and the access password input by the user may be transmitted to the accessing device via broadcasting. Upon receiving a broadcasting diagram, the accessing device in the listening state may extract the SSID and the access password therefrom, so as to establish a network connection with a designated router by transmitting an access request to the router. Thus, an accuracy of the SSID and the access password obtained by the accessing device may be improved, and a success rate for the accessing device to access the router is improved.

FIG. 2 is a flow chart illustrating a method for accessing network according to another exemplary embodiment. As shown in FIG. 2, the method may alternatively include following steps.

In step S21, prompting to select the SSID and the access password input or the SSID and the access password in the historical network access data record if the SSID and the access password input do not match the SSID and the access password in the historical network access data record; in step S22, hiding the SSID and the access password in the historical network access data record when the SSID and the access password in the historical network access data record is selected; and in step S23, transmitting the selected SSID and the access password in the historical network access data record to the accessing device.

In the alternative embodiment, the terminal device may prompt the user if the SSID and the access password input by the user do not match those saved in the historical data record, so that the user may select the SSID and the access password input by himself/herself or the SSID and the access password in the historical data record to be broadcasted to the accessing device. If the SSID and the access password in the historical data record are selected by the user, the terminal device may directly broadcast the SSID and the access password to the accessing device without notifying the user of the SSID and the access password. Thus, the accessing device may be enabled to perform the access with the SSID and the access password of a router which was accessed, so a success rate of accessing network may be improved. In addition, the SSID and the access password in the historical data record are not displayed on the terminal device, so confidentiality related to the SSID and the access password of the router may be improved.

FIG. 3 is a flow chart illustrating a method for accessing network according to yet another exemplary embodiment. As shown in FIG. 3, the step S13 may alternatively include following steps.

In step S31, accessing the corresponding server based on the SSID and the access password input; and in step S32, transmitting the SSID and the access password input to the accessing device if the corresponding server is successfully accessed.

In the alternative embodiment, the terminal device may try to access the corresponding server with the SSID and the access password input by the user before broadcasting the SSID and the access password. Thus, it may be deemed that the SSID and the access password are correct and the corresponding server functions normally if the access succeeds, so the success rate for the accessing device to access the corresponding server may be further improved.

Alternatively, the method may further include: prompting a failure to access the router if the corresponding server is not successfully accessed.

In the alternative embodiment, the terminal device may fail to access the corresponding server due to wrong SSID or password, or malfunction of the corresponding server. Thus, the terminal device may prompt the user to look into a cause of failure according to a prompt, so the success rate for the accessing device to access the corresponding server may be further improved.

FIG. 4 is a flow chart illustrating a method for accessing network according to an exemplary embodiment. As shown in FIG. 4, the method for accessing network may be implemented by a terminal device, and may include following steps.

In step S41, prompting to input an SSID and an access password for accessing a router when a network access request is received from an accessing device; in step S42, accessing the server based on the SSID and the access password input; and in step S43, transmitting the SSID and the access password input to the accessing device if the server is successfully accessed, so that the accessing device may access the server based on the SSID and the access password transmitted by the terminal device.

In the present embodiment, the terminal device may try to access the corresponding server with the SSID and the access password input by the user before broadcasting the SSID and the access password, and it may be deemed that the SSID and the access password are correct and the server functions normally if the access succeeds. Thus, an accuracy of the SSID and the access password obtained by the accessing device may be improved, and a success rate for the accessing device to access the router is improved.

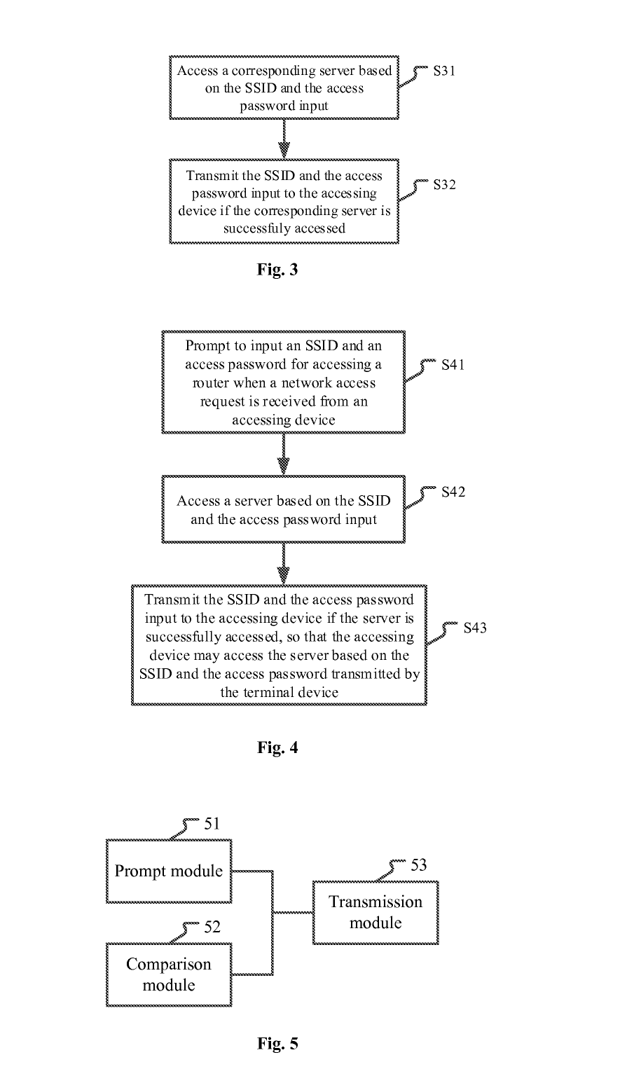

FIG. 5 is a block diagram illustrating an apparatus for accessing network according to an exemplary embodiment. As shown in FIG. 5, the apparatus may be included in a terminal device, and may include a prompt module 51, a comparison module 52 and a transmission module 53.

The prompt module 51 is configured to prompt to input an SSID and an access password for accessing a router when a network access request is received from an accessing device; the comparison module 52 is configured to compare the SSID and the access password input with an SSID and an access password in a prestored historical network access data record; and the transmission module 53 is configured to transmit the SSID and the access password input to the accessing device if the SSID and the access password input match the SSID and the access password in the historical network access data record, so that the accessing device may access the corresponding server based on the SSID and the access password transmitted by the terminal device.

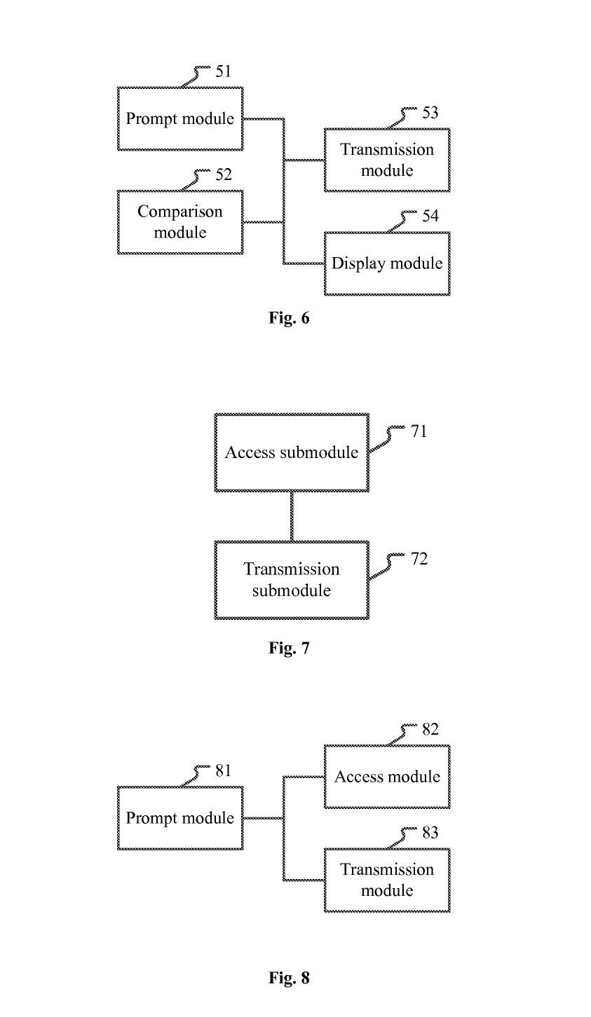

FIG. 6 is a block diagram illustrating an apparatus for accessing network according to another exemplary embodiment. As shown in FIG. 6, the apparatus may further include a display module 54.

The prompt module 51 is further configured to prompt to select the SSID and the access password input or the SSID and the access password in the historical network access data record if the SSID and the access password input do not match the SSID and the access password in the historical network access data record; the display module 54 is configured to hide the SSID and the access password in the historical network access data record when the SSID and the access password in the historical network access data record is selected; and the transmission module 53 is further configured to transmit the selected SSID and the access password in the historical network access data record to the accessing device.

FIG. 7 is a block diagram illustrating an apparatus for accessing network according to an exemplary embodiment. As shown in FIG. 7, the transmission module 53 may alternatively include: an access submodule 71 configured to access the corresponding server based on the SSID and the access password input; and a transmission submodule 72 configured to transmit the SSID and the access password input to the accessing device if the corresponding server is successfully accessed.

Alternatively, the prompt module 51 is further configured to prompt a failure to access the router if the corresponding server is not successfully accessed.

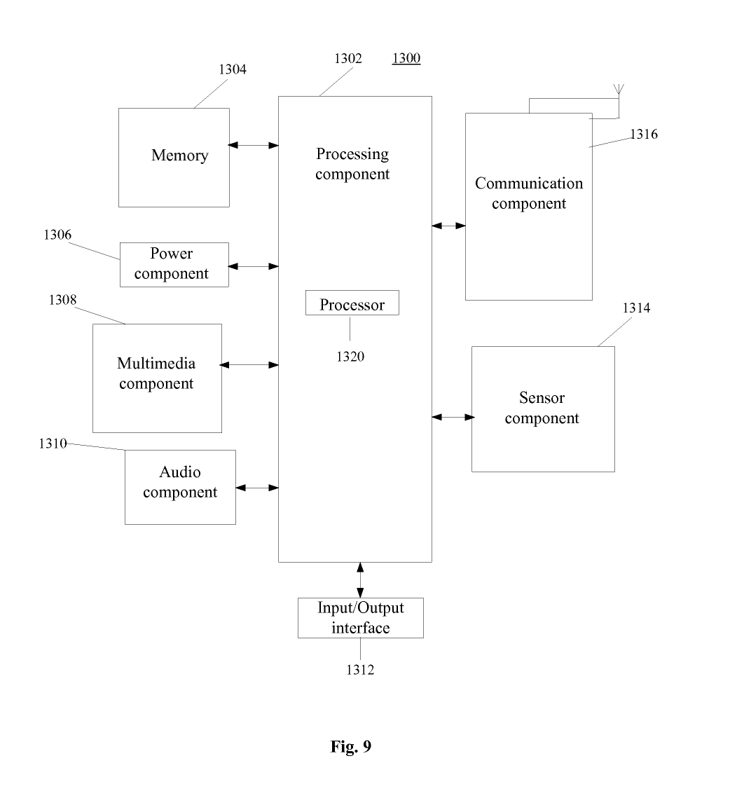

FIG. 8 is a block diagram illustrating an apparatus for accessing network according to an exemplary embodiment. As shown in FIG. 8, the apparatus may be included in a terminal device, and may include a prompt module 81, a comparison module 82 and a transmission module 83.

The prompt module 81 is configured to prompt to input an SSID and an access password for accessing a router when a network access request is received from an accessing device; the access module 82 is configured to access the corresponding server based on the SSID and the access password input; and the transmission module 83 is configured to transmit the SSID and the access password input to the accessing device if the corresponding server is successfully accessed, so that the accessing device may access the corresponding server based on the SSID and the access password transmitted by the terminal device.

With respect to the apparatus in the above embodiments, the specific manners for performing operations for respective modules therein have been described in detail in the embodiments regarding the method, which will not be elaborated herein.

The present disclosure further provides a terminal device for accessing network, including: a processor; and a memory for storing instructions executable by the processor; wherein the processor is configured to perform: prompting to input an SSID and an access password for accessing a router when a network access request is received from an accessing device; comparing the SSID and the access password input with an SSID and an access passwords in a historical network access data record; and transmitting the SSID and the access password input to the accessing device if the SSID and the access password input match the SSID and the access password in the historical network access data record, the accessing device accessing the corresponding server based on the SSID and the access password transmitted by the terminal device.

The present disclosure further provides a terminal device for accessing network, including: a processor; and a memory for storing instructions executable by the processor; wherein the processor is configured to perform: prompting to input an SSID and an access password for accessing a router when a network access request is received from an accessing device; accessing the server based on the SSID and the access password input; and transmitting the SSID and the access password input to the accessing device if the server is successfully accessed, and the accessing device accessing the server based on the SSID and the access password transmitted by the terminal device.

FIG. 9 is a block diagram illustrating a terminal device used for accessing network according to an exemplary embodiment. For example, the terminal device 1300 may be any one selected from a group including a mobile phone, a computer, a digital broadcast terminal device device, a messaging device, a gaming console, a tablet, a medical device, an exercise equipment, a personal digital assistant (PDA), and the like.

Referring to FIG. 9, the terminal device 1300 may include one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 generally controls overall operations of the terminal device 1300, such as operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the terminal device 1300. Examples of such data include instructions for any application or method operated on the terminal device 1300, contact data, phonebook data, messages, pictures, videos, etc. The memory 1304 may be implemented using any type of volatile or non-volatile memory apparatus or combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or an optical disk.

The power component 1306 provides power to various components of the terminal device 1300. The power component 1306 may include a power management system, one or more power sources, and other components associated with the generation, management, and distribution of power in the terminal device 1300.

The multimedia component 1308 includes a screen providing an output interface between the terminal device 1300 and the user. In some embodiments, the screen may include a liquid crystal display (LCD) and a touch panel (TP). If the screen includes the touch panel, the screen may be implemented as a touch screen to receive input signal from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 1308 includes a front camera and/or a rear camera. The front camera and/or the rear camera may receive an external multimedia datum while the terminal device 1300 is in an operation mode, such as a photographing mode or a video mode. Each of the front camera and the rear camera may be a fixed optical lens system or have focus and optical zoom capability.

The audio component 1310 is configured to output and/or input audio signal. For example, the audio component 1310 includes a microphone (MIC) configured to receive external audio signal when the terminal device 1300 is in an operation mode, such as a call mode, a recording mode, and a voice identification mode. The received audio signal may be further stored in the memory 1304 or transmitted via the communication component 1316. In some embodiments, the audio component 1310 further includes a speaker to output audio signal.

The I/O interface 1312 provides an interface between the processing component 1302 and peripheral interface modules, such as a keyboard, a click wheel, a button, or the like. The button may include, but not limited to, a home button, a volume button, a starting button, or a locking button.

The sensor component 1314 includes one or more sensors to provide status assessments of various aspects of the terminal device 1300. For instance, the sensor component 1314 may detect an open/closed status of the terminal device 1300, relative positioning of components, e.g., the display and the keyboard, of the terminal device 1300, a change in position of the terminal device 1300 or a component of the terminal device 1300, a presence or absence of user contact with the terminal device 1300, an orientation or an acceleration/deceleration of the terminal device 1300, and a change in temperature of the terminal device 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate communication, wired or wirelessly, between the terminal device 1300 and other apparatuses. The terminal device 1300 may access a wireless network based on a communication standard, such as WIFI, 2G, or 3G, or a combination thereof. In one exemplary embodiment, the communication component 1316 receives broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In exemplary embodiments, there is also provided a non-transitory computer readable storage medium including instructions, such as instructions included in the memory 1304, executable by the processor 1320 in the terminal device 1300, for performing the above method. For example, the non-transitory computer-readable storage medium may be a ROM, a random access memory (RAM), a CD-ROM, a magnetic tape, a floppy disc, an optical data storage apparatus, or the like.

A non-transitory computer-readable storage medium includes instructions, executable by a processor of a mobile terminal device, to enable the mobile terminal device to perform a method for accessing network. The method includes: prompting to input an SSID and an access password for accessing a router when a network access request is received from an accessing device; comparing the SSID and the access password input with an SSID and an access password in a historical network access data record; and transmitting the SSID and the access password input to the accessing device if the SSID and the access password input match the SSID and the access password in the historical network access data record, the accessing device accessing the corresponding server based on the SSID and the access password transmitted by the terminal device.

A non-transitory computer-readable storage medium includes instructions, executable by a processor of a mobile terminal device, to enable the mobile terminal device to perform a method for accessing network. The method includes: prompting to input an SSID and an access password for accessing a router when a network access request is received from an accessing device; accessing the server based on the SSID and the access password input; and transmitting the SSID and the access password input to the accessing device if the server is successfully accessed, and the accessing device accessing the corresponding server based on the SSID and the access password transmitted by the terminal device.

For example, other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for accessing network, implemented by a terminal device, comprising:
prompting to input a Service Set Identifier (SSID) and an access password for accessing a router when a network access request is received from an accessing device;
comparing the SSID and the access password input with an SSID and an access password in a historical network access data record; and
transmitting the SSID and the access password input to the accessing device if the SSID and the access password input match the SSID and the access password in the historical network access data record, the accessing device accessing a corresponding server based on the SSID and the access password transmitted by the terminal device.

2. The method according to claim 1, further comprising:
prompting to select the SSID and the access password input or the SSID and the access password in the historical network access data record if the SSID and the access password input do not match the SSID and the access password in the historical network access data record;
hiding the SSID and the access password in the historical network access data record when the SSID and the access password in the historical network access data record is selected; and
transmitting the selected SSID and access password in the historical network access data record to the accessing device.

3. The method according to claim 1, wherein transmitting the SSID and the access password input to the accessing device comprises:
accessing the corresponding server based on the SSID and the access password input; and
transmitting the SSID and the access password input to the accessing device if the corresponding server is successfully accessed.

4. The method according to claim 3, further comprising:
prompting a failure to access the router if the corresponding server is not successfully accessed.

5. A terminal device for accessing network, comprising:
a processor; and
a memory for storing instructions executable by the processor;
wherein the processor is configured to perform:
prompting to input a Service Set Identifier (SSID) and an access password for accessing a router when a network access request is received from an accessing device;
comparing the SSID and the access password input with an SSID and an access passwords in a historical network access data record; and
transmitting the SSID and the access password input to the accessing device if the SSID and the access password input match the SSID and the access password in the historical network access data record, the accessing device accessing a corresponding server based on the SSID and the access password transmitted by the terminal device.

6. The terminal device according to claim 5, wherein the processor is further configured to perform:
prompting to select the SSID and the access password input or the SSID and the access password in the historical network access data record if the SSID and the access password input do not match the SSID and the access password in the historical network access data record;
hiding the SSID and the access password in the historical network access data record when the SSID and the access password in the historical network access data record is selected; and
transmitting the selected SSID and the access password in the historical network access data record to the accessing device.

7. The terminal device according to claim 5, wherein transmitting the SSID and the access password input to the accessing device comprises:
accessing the corresponding server based on the SSID and the access password input; and
transmitting the SSID and the access password input to the accessing device if the corresponding server is successfully accessed.

8. The terminal device according to claim 7, wherein the processor is further configured to perform:
prompting a failure to access the router if the corresponding server is not successfully accessed.

9. A non-transitory computer-readable storage medium having stored therein instructions that, when executed by a processor of a terminal device, cause the terminal device to perform a method for accessing network, the method comprising:
prompting to input a Service Set Identifier (SSID) and an access password for accessing a router when a network access request is received from an accessing device;
comparing the SSID and the access password input with an SSID and an access passwords in a historical network access data record; and
transmitting the SSID and the access password input to the accessing device if the SSID and the access password input match the SSID and the access password in the historical network access data record, the accessing device accessing the corresponding server based on the SSID and the access password transmitted by the terminal device.

10. The non-transitory computer-readable storage medium according to claim 9, wherein the method further comprises:
prompting to select the SSID and the access password input or the SSID and the access password in the historical network access data record if the SSID and the access password input do not match the SSID and the access password in the historical network access data record;
hiding the SSID and the access password in the historical network access data record when the SSID and the access password in the historical network access data record is selected; and
transmitting the selected SSID and the access password in the historical network access data record to the accessing device.

11. The non-transitory computer-readable storage medium according to claim 9, wherein transmitting the SSID and the access password input to the accessing device comprises:
accessing the corresponding server based on the SSID and the access password input; and
transmitting the SSID and the access password input to the accessing device if the corresponding server is successfully accessed.

12. The non-transitory computer-readable storage medium according to claim 11, wherein the method further comprises:
prompting a failure to access the router if the corresponding server is not successfully accessed.
